(19) United States
(12) Patent Application Publication
(10) Pub. No.: US 2003/0135647 A1
(43) Pub. Date: Jul. 17, 2003

(54) Web browser control of telephone directories

(75) Inventors: Maria Azua Himmel, Yorktown Heights, NY (US); Clifford Jay Spinac, Austin, TX (US); Newton James Smith JR., Austin, TX (US); Clifford Jay Spinac, Austin, TX (US)

Correspondence Address: Jeffrey L. Streets, Suite 355, 13831 Northwest Freeway, Houston, TX, 77040, US

(73) Assignee: INTERNATIONAL BUSINESS MACHINES CORPORATION, ARMONK, NY

(21) Appl. No.: 10/047,003

(22) Filed: Jan. 16, 2002

(51) Int. Cl. G06F 15/16

(52) U.S. Cl. 709/245; 709/219

(57) ABSTRACT

A method and system for sending a telephone number record from a browser to at least one user device having an electronic telephone directory. The method includes recording in the browser a destination address of a user device that contains an electronic telephone directory, entering a telephone number record into a browser dialogue box, and transmitting the telephone number record to the user device identified or associated with the destination address. The telephone number record is then recorded in the electronic telephone directory. Preferably, the content and format and other aspects of the record are determined in accordance with a user customizable profile.

### BACKGROUND OF THE INVENTION

1. Field of the Invention

The present invention relates to electronic telephone directories and, more specifically, to a method by which an electronic telephone directory can be updated.

2. Description of the Related Art

The Internet has provided businesses and consumers with a wealth of information in many forms including, for example, information on repairing appliances and purchasing automobiles, and the price and delivery of goods and services. Business enterprises have found the Internet to be quite profitable by allowing them to reach many customers around the world and therefore, most large companies and many small companies now have web sites. While the effect of the proliferation of the Internet has been to decrease the amount of personal contact between a customer and a business, it has not totally replaced it. Customers and businesses still have the need to communicate directly and personally. For this reason, a web site will often publish telephone numbers for use by customers that want to contact the business as necessary or as desired.

Because telephone companies often charge for providing telephone numbers from directory assistance, many people connect with a business enterprise's web site to obtain a contact telephone number. Also, because large corporations may have many different telephone numbers for different locations and departments, the web site may provide customers with the direct telephone number for the department or person they wish to contact without having to go through a series of separate telephone calls.

After obtaining a telephone number, many people want to store the telephone number in a telephone directory for future reference or for the convenience of dialing. Electronic telephone directories may be found in many types of user devices, for example, mobile telephones, personal computers, and personal digital assistants (PDAs). Usually telephone numbers stored in such devices can be searched, selected, and then dialed automatically without having to dial each digit of the telephone number manually. For example, a mobile telephone often has a directory function for storing telephone numbers. Telephone numbers are usually added to the directory or updated using keystrokes on the mobile telephone's keypad. Alphanumeric references that improve subsequent identification and retrieval of the telephone number must also be entered using the keys on the keypad. The mobile telephone can then scroll through the numbers or, by using alphanumeric keys, can search for and find a number assigned to a party and then automatically dial the selected stored telephone number. In some telephone systems the called party's name can be spoken and the telephone will use word recognition to retrieve the called party's number and then dial it.

Therefore, there is a need for a method of entering telephone numbers into a remote telephone directory. It would be desirable if the method allowed telephone numbers listed on a web site to be sent electronically to a remote user device. It would be desirable if the user device could be a personal computer, personal digital assistant, or a mobile telephone. Even more desirably, the method would allow for managing the telephone directories of multiple user devices owned by the user.

### SUMMARY OF THE INVENTION

The present invention provides a method for transmitting a telephone number record from a browser to one or more user devices that each have an electronic telephone directory and a specific destination address. The method includes recording the destination address of the user device in the user's browser, creating or forming one or more telephone number records into the browser, and sending the one or more telephone number records to the user device. Preferably, the browser contains the user's preferences and instructions regarding what user devices are intended to receive the telephone number records. Accordingly, the telephone number records may be transmitted directly from the browser through a communications network to the telephone number directory of user devices.

The telephone number record will typically include a telephone number and an alphanumeric identifier for the telephone number, yet may also include parameters or additional information selected from a contact name, address, FAX number, e-mail address, hyperlink to a web site, business name, business specialty, business hours or combinations thereof. The telephone number record may be sent to various types of user devices, such as a PDA, personal computer, mobile telephone or any other communications device where the telephone number record is then recorded in an electronic telephone directory.

Although the user may provide the telephone number to the browser in various ways, such as by typing with the keyboard, pasting text from other software applications, voice recognition, and stylus entry, it is preferred that the user select and capture the telephone number from a web page. For example, a preferred method to select and capture the telephone number includes highlighting the desired telephone number on the web page and then right-clicking on the highlighted area to cause the browser to open the telephone number record dialogue box and enter the highlighted telephone number into the telephone number field of a new telephone number record. The browser dialogue box relies upon the user to provide any additional information into other fields of the new telephone number record. Accordingly, portions of the new telephone number record may be keyed into the record by the user from any source, such as a phone book, web page, telephone directory information (1411), or a notecard.

The user devices may be any one or more electronic components that can store and retrieve information and is connectable to a telephone network or a computer network. Examples of a user device include, without limitation, a mobile telephone, personal computer, voice mail messaging service, FAX machine, handheld computer, personal digital assistant, or combinations thereof. The address for the user device could be, for example, a telephone number, an Internet address, or a computer network address.

Preferably, the user enters the destination address for each user device into the browser preferences so that each destination address is maintained and available when the user desires to transmit telephone number records. Accordingly, a telephone number record may be sent to each user device having its destination address listed in the preferences and/or the telephone number record may be sent to an electronic telephone directory within the originating user device itself.

When the user has found a desired telephone number on a web page, the user captures the telephone number into a browser dialogue box, and then provides additional information related to the telephone number, such as a name or address, into the dialogue box in order to create an enhanced telephone number record. In this manner, a telephone number record is created regardless of whether or not the web page or web server has been enabled to automatically provide a telephone number record.

After the user has created the desired telephone number record, the browser generates a message directed to one or more user devices in accordance with each destination address provided by the user in the browser preferences. It is preferred to mark the message in a way that indicates to the user device that the received message contains a telephone number record. In this manner, the receiving user device will process the message as instructed for an incoming telephone number record. Optionally, the browser may provide a notification to the user, such as with a pop up message, that the message has been sent or that the message was successfully sent to the one or more user devices.

After receiving the message, the receiving user device handles the telephone number record in accordance with user preferences set up within that device. Preferably, the telephone number record is automatically recorded into the electronic telephone directory maintained within the user device. Alternatively, the electronic telephone directory may first search the existing telephone number records to determine if the directory already contains the telephone number record received in the message. Optionally, a password may have been included in the address of the user device and marked on the message sent by the server. If the password marked on the message does not match the password for the user device, the message may be discarded as an unauthorized message.

In one embodiment of the invention, the user preferences maintained with the user's browser will allow the user to specify multiple user devices that should receive the same telephone number records, thereby maintaining identical telephone number directories. The advantage of exercising this option is that the user can access all telephone number records regardless of which user device is presently being using.

The foregoing and other objects, features and advantages of the invention will be apparent from the following more particular description of a preferred embodiment of the invention, as illustrated in the accompanying drawings wherein like reference numbers represent like parts of the invention.

### BRIEF DESCRIPTION OF THE DRAWINGS

FIG. 1 is a schematic diagram showing an originating user device and two destination user devices over a network in accordance with the present invention.

FIG. 2 is a schematic diagram of a destination user device in the form of a mobile telephone.

FIG. 3 is an example of a computer system suitable for use as either an originating user device or a destination user device.

FIGS. 4A and 4B provide a flow chart of a method for transmitting a telephone number record from an originating user device to a destination user device.

### DETAILED DESCRIPTION OF THE INVENTION

The present invention provides a method for sending a telephone number record from a web browser to at least one destination user device for recording in an electronic telephone directory within the at least one destination user device. Furthermore, the telephone number record may be sent to an electronic telephone directory in the originating user device itself. Destination user devices may include other network-connected computers, personal digital assistants, mobile telephones, facsimile machines, and the like. Preferably, the browser is capable of maintaining an ongoing list of destination addresses in its preferences, so that telephone number records may be sent without requiring re-entry of the destination addresses. The destination address provides an instruction or path for reaching the destination user device. This instruction or path may then be used by the originating user device for sending the telephone number record to the at least one destination user device. The browser preferences may also optionally include storage of passwords for each destination user device and the telephone directory formats or capabilities of each destination user device.

The present invention is advantageous in maintaining or updating multiple telephone directories with the same information without requiring laborious manual re-entry of every telephone number record into each user device and without requiring specific knowledge of the unique processes for entering telephone number records into each user device. In this manner, a user or owner of multiple user devices that each have a telephone directory can have access to all of the telephone numbers desired regardless of which user device the user presently has available, such as a mobile phone, a spouse's mobile phone, PDA, office computer, home computer, and the like.

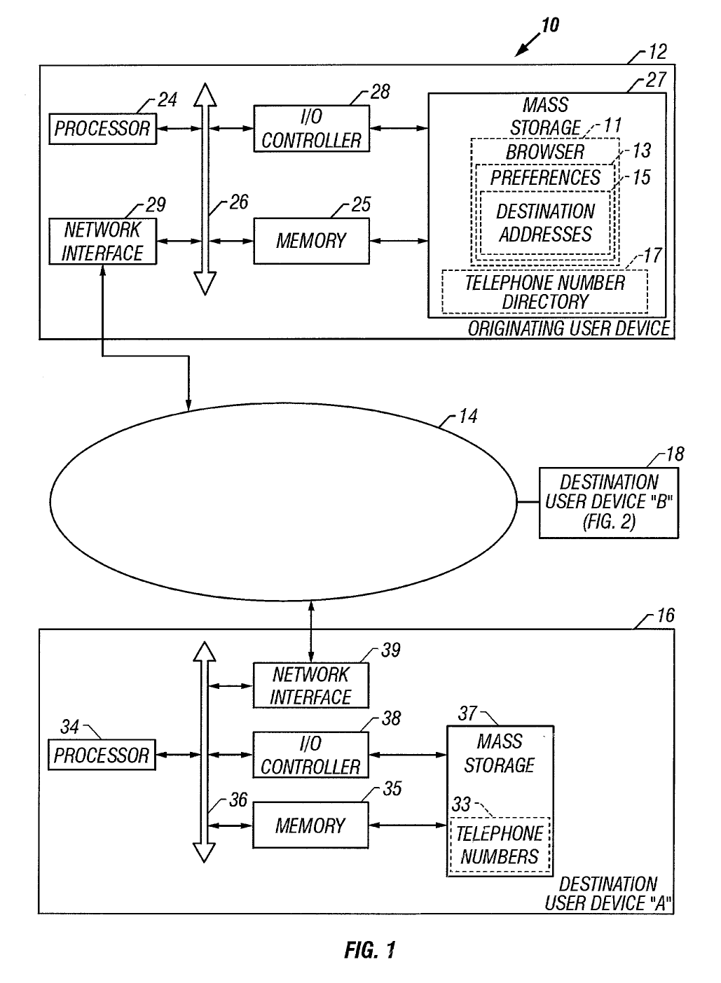

FIG. 1 is a schematic diagram showing the system 10 of the present invention. An originating user device 12, such as computer, PDA or mobile telephone, is shown in communication with a communication system or network 14. The communications network 14 is the medium used to provide communications links between various devices and computers connected together within the system 10. The communications network 14 may include permanent connections, such as wire or fiber optic cables, or temporary connections made through telephone or wireless communications. The originating user device 12, as well as the destination user devices 16, 18 may be a variety of devices, such as mainframe computers, personal computers, personal digital assistants (PDAs), mobile telephones, or facsimile machines. It should be recognized that the system 10 may include additional servers, clients, routers and other devices not shown. Furthermore, the system 10 may utilize a network 14, such as the Internet, representing a worldwide collection of networks and gateways that use the TCP/IP suite of protocols to communicate with one another. Of course, the system 10 may also utilize a number of different types of networks, such as, for example, an intranet, a local area network (LAN), a wide area network (WAN), or a wireless network.

The originating user device 12 includes conventional components such as a processor 24, memory 25 (e.g. RAM), a bus 26, a mass storage device 27 (e.g. a magnetic hard disk or an optical storage disk) coupled to the bus 26 through an I/O controller 28, and a network interface 29, such as a conventional modem. The user device further includes the browser 11 which includes a preferences file 13 with destination addresses 15 and the telephone number directory 17.

It will be appreciated from the description below that the present invention may be implemented in software that is stored as executable instructions on a computer readable medium on the user's system, such as mass storage device 27 or in memory 25. These instructions would include, for example, an operating system program, application programs, and a browser program. The user device 12 is thus suitable for processing: (1) entry of a telephone number record, (2) storing a telephone number record, and (3) optionally, generating a message containing the telephone number record to be sent to a remote user device having an electronic telephone number directory. Furthermore, although the preferred embodiment described below includes a “browser” 11 in the originating user device 12 as the agent exchanging data in the security protocols with the web Application Server, the agent does not have to be a conventional browser, e.g. Netscape Navigator® or Microsoft Internet Explorer®, but rather could be a mobile telephone or any device capable of processing the telephone number record request. In order to secure the information transmitted to and from the server, the user device may be capable of Public Key Infrastructure (PKI) technology exchanged in a security protocol such as the Secure Sockets Layer (SSL) version 3.0 and above.

The destination user devices 16, 18 may be any devices that can store and retrieve information and is connectable to a communications network, which may include both computer networks and telephone networks. Examples may be a mobile telephone, a personal computer, a voice mail messaging service, a FAX machine, a handheld computer, a personal digital assistant, or combinations thereof. The destination address for the user device could be, for example, a telephone number, an Internet address, or a computer network address.

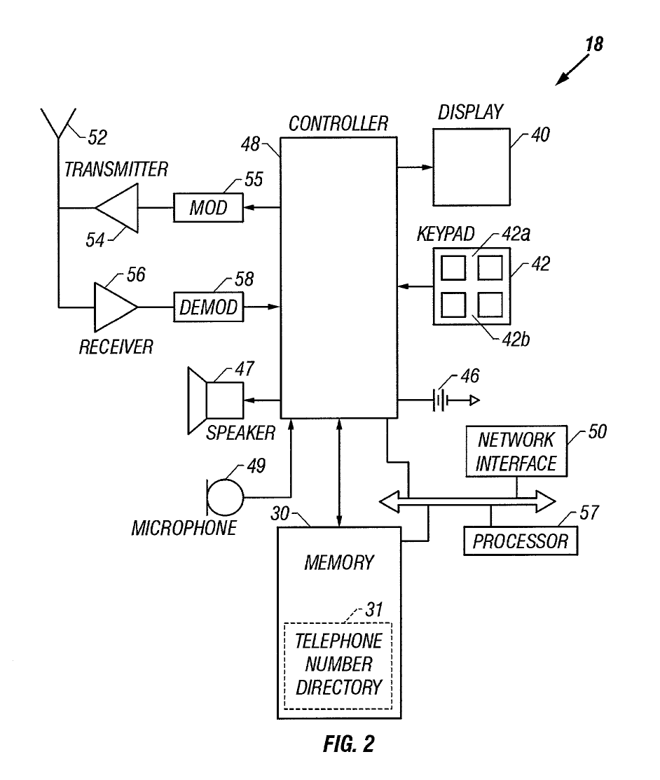

The destination user device 16 is shown as a computer, including conventional components such as a processor 34, memory 35 (e.g. RAM), a bus 36, a mass storage device 37 (e.g. a magnetic hard disk or an optical storage disk) coupled to the bus 36 through an I/O controller 38, and a network interface 39, such as a conventional modem. The user device further includes a telephone number directory 33. Other types of destination user devices may also be used in accordance with the invention, such as the destination user device 18, shown in more detail in FIG. 2 as a mobile telephone.

The browser software includes an application program that enables the browser to send a message to the electronic telephone directory (such as directories 17 or 33) located within the user device associated with, or identified by, the destination address. The browser may obtain the destination address either by prompting the user to enter an address into a dialogue box or, more preferably, by accessing destination addresses 15 that the user has previously embedded into the preferences 13 of the browser 11 running on the originating user device 12. The telephone number record is then sent, transferred or copied to the electronic telephone directory of the user device located at the destination address. If the address is that of the user device 12, then the telephone number record is copied directly to the user device 12 to be saved in the electronic telephone number directory 17. However, if the destination address is that of another user device 16, 18, then the user device 12 transfers the telephone number record to the user device 16, 18. A suitable electronic telephone directory may be contained in any user device that is capable of communicating over the communications network.

FIG. 2 is a schematic diagram of destination user device 18 in the form of a mobile telephone suitable for use in accordance with the present invention. The mobile telephone 18 (includes an antenna 52 for transmitting signals to and from a mobile telephone network, which is part of the communications network. The mobile telephone 18 includes a modulator 55, a transmitter 54, a demodulator 58, a receiver 56, and a controller 48 that provides signals to the transmitter and receives signals from the receiver. These signals include audio and/or computer readable files. Also connected to the controller 48 are a conventional speaker 47, microphone 49, display 40, and input device, typically a keypad 42. The keypad includes keys 42a, which are numeric and alphanumeric keys typically found on a telephone, and other keys 42b, used for operating the mobile telephone including, but not limited to, a power key, a SEND key, and various menu scrolling and other keys. Also included are a processor 57 and a network interface 50, such as a conventional modem, and a battery power source 46.

The mobile telephone 18 also includes memory 30 that stores the values of various mobile system parameters and the number assignment module (NAM). It also stores telephone number records in a database directory 31 containing telephone numbers with their related alphanumeric identifiers. The database may be searched and a telephone number selected, and then automatically dialed by the mobile telephone system. The telephone operating system contains the programmed instructions to operate the telephone and the telephone's features, such as the electronic telephone directory and the directory's search and automatic dialing functions.

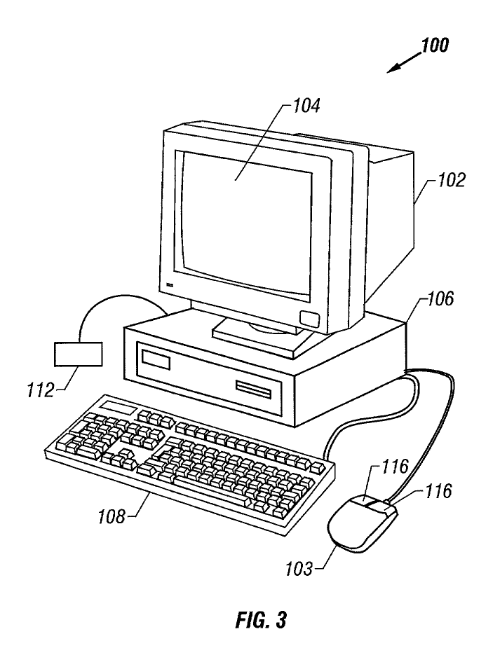

FIG. 3 shows a computer system 100 capable of running a browser or other document processor. The computer system 100 includes a display device 102 (such as a monitor), a display screen 104, a cabinet 106 (which encloses components typically found in a computer, such as CPU, RAM, ROM, video card, hard drive, sound card, serial ports, etc.), a keyboard 108, a mouse 103 and a modem 112. The mouse 103 may have one or more buttons, such as buttons 116. The computer requires some type of communication device such as modem 112 that allows computer system 100 to be connected to the Internet, e.g. via a telephone line. Other possible communication devices include ethernet network cards connected to a LAN.

Preferably, the user records the destination address for the user device in the preferences of the browser so that the user D, device and/or the server may read and use the address. By using a menu function on the browser, the user specifies the address on an interactive display provided by the browser. Alternatively, the user could record multiple addresses associated with multiple user devices and then, when the user selects the telephone number record to capture, indicate at that time which of the user devices should receive the telephone number record.

The telephone number record that is entered will normally contain the telephone number and an alphanumeric identifier for the telephone number. Alternatively, the telephone number record may contain additional parameters, such as an address associated with the telephone number, a FAX number, an e-mail address, a hyperlink to the web site, a business name, a contact name, hours of operation and combinations thereof. Additionally, the telephone number record could contain business hours for a business that are specific to the telephone number selected (for example, the hours that the customer service department is open), information on the business's specialty, advertising information and combinations thereof. Even after entering information into the appropriate fields of the telephone number record formed in the browser, the browser may send the telephone number record in a format that is suitable for the type of user device that will be receiving the record (for example, sending graphics files of appropriate resolution). While most electronic telephone directories may only contain a telephone number and an alphanumeric identifier, there are computer based electronic telephone directories that have fields for recording additional information such as those suggested above.

In one embodiment, the user may click a browser button, fill in the required telephone number record information in a dialogue box displayed by the browser, and then send a message from the originating user device with the browser to the electronic a telephone directory, where the message contains the telephone number record as entered by the user in the dialogue box.

Optionally, after entering one telephone number record in the dialogue box, the user may enter additional records to be sent simultaneous with, or subsequent to, the first telephone number record. Additionally, the user may edit the telephone number record by changing the alphanumeric identifier to better suit the filing system used by the user in the electronic telephone directory. The user may also edit the telephone number to be compatible with the user's telephone system to include, for example, adding a country code, a “1” if the number will be long distance, or a “9” for reaching an outside line. Furthermore, if the telephone number record displayed on the web page includes additional information, such as an e-mail address or business hours, the user may edit that information to remove it from the transmission to certain destination user devices or device types, or edit the information to make the information compatible with the format of the telephone number directory that will receive the information. Preferably, the displayed information will be in business card format or other standard format to minimize or alleviate the need to edit the information by the user.

After the user has completed entry of the telephone number record, the originating user device generates a message to send to the address of the destination user device. If the originating user device cannot find the address in its browser, then the originating user device notifies the user that an address has not been provided and requests the user to add an address to the browser. The form of the address will allow the originating user device or the server to identify whether to send the message over the Internet or over the telephone network.

Before dispatching the message to the address of the user device, it is preferred that the browser mark the message to identify the message as one containing a telephone number record. Additionally, if the destination address recorded in the browser includes a password, the message may be appended to include the password. With the marking indicating that the message contains a telephone number record, the destination user device will process the message as instructed for an incoming telephone number record. Alternatively, if the message is marked with a password, and the password does not match the password of the user device, then the user device may discard the message or take other action as instructed for an incoming telephone number record with an incorrect or missing password, such as notifying the user.

When the destination user device receives a message marked as one containing a telephone number record, the user device notifies the user that a telephone number record message has been received. The user device may provide the notification by ringing the telephone as for a normal call or short message, or may display a visual notification, or perform other such action as instructed and as is suitable for the type of user device receiving the message.

It is preferred to automatically record the telephone number record into the electronic telephone directory of the destination user device upon receiving the message. Alternatively, the electronic telephone directory may first search the existing telephone number records to determine if the directory already contains the telephone number record received in the message. If there is no duplication of records, then the telephone number record is recorded. If there is duplication, then the electronic telephone directory queries the user whether to update the existing record or delete the telephone number record that was received in the message. Furthermore, if the telephone number record included additional data other than telephone number and alphanumeric identifier, the duplication search could be applied to each of the additional fields.

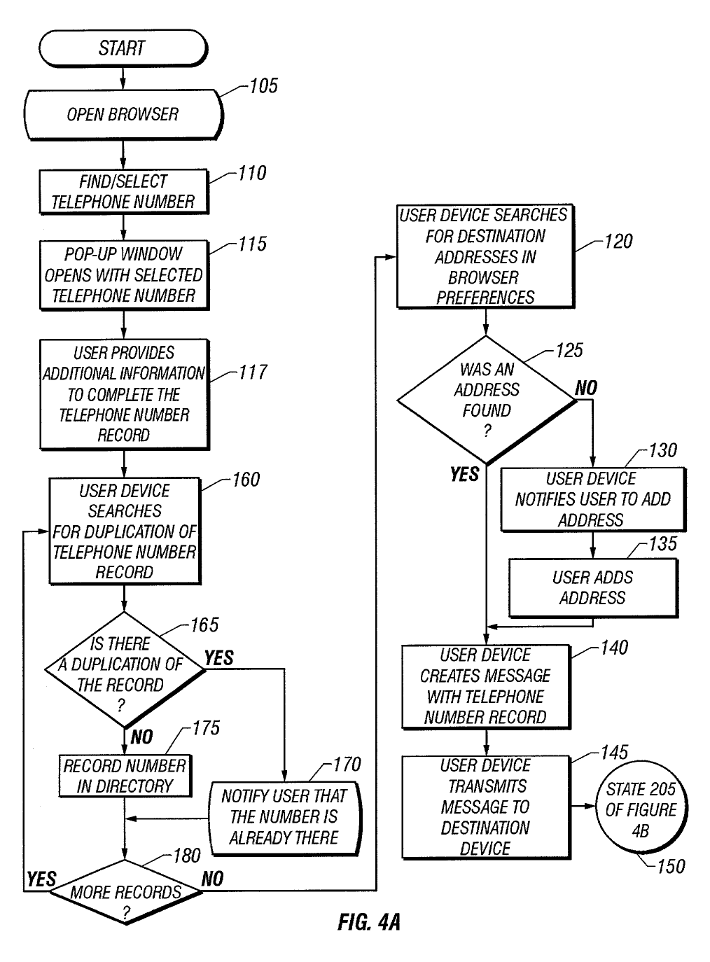

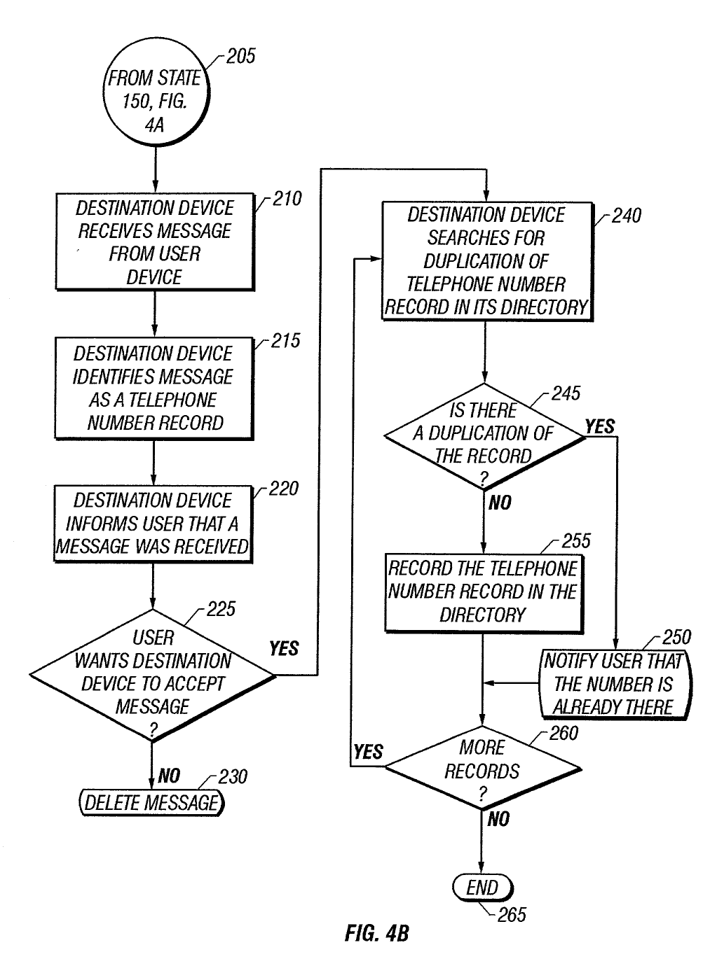

FIG. 4A is a flow chart of a method that may be executed on the system of FIG. 1. In state 105, the originating user device 15 opens the browser 11. In state 110, the user finds and selects a telephone number, such as a telephone number displayed on a web page. In state 115, the user causes a pop-up window or dialogue box to open containing the telephone number that the user selected. In state 117, the user then provides any additional information desired to complete the telephone number record that is to be recorded in an electronic telephone directory, such as the originating user device directory 17, destination user device directory 33, or mobile telephone directory 31.

Upon completing the entry of the telephone number record, the originating user device, in state 160, searches the electronic telephone directory 17 to determine whether the telephone number record is already recorded there. If, in state 165, it is determined that the record is a duplication, then in state 170, the originating user device notifies the user that the telephone number has previously been recorded so that appropriate action can be taken, such as instructing the electronic telephone directory to only update the fields that have changed. If, in state 165, the telephone number record is not a duplication, then in state 175, the telephone number is recorded in the electronic telephone directory 17 of the originating user device. If, in state 180, there is still another telephone number record to be searched for, then the method repeats state 160 through state 180 as discussed above.

If, in state 180, there are no further telephone number records entered, the originating user device then searches, in state 120, within the browser preferences 13 for embedded destination addresses 32 identifying user devices containing an electronic telephone directory. The destination address may be, for example, a computer network address, an Internet address or a telephone number.

If, in state 125, the originating user device finds an embedded address, then, in state 140, the originating user device 12 creates a message containing the selected telephone number record to be added to the electronic telephone directory. In state 145, the originating user device uses the embedded destination address to transmit the message to the destination user device and, in state 150, the method continues to state 205 of FIG. 4B. If, in state 125, the originating user device 12 cannot find a destination address in the browser preferences, then in state 130, the originating user device 12 notifies the user that a destination address has not been found and prompts the user to enter an address or add the address to the browser preferences 13. In state 135, the user provides the address to the browser. Then, the method continues as in states 140 through 150 as discussed above.

In FIG. 4B, the method continues with state 205, from state 150 of FIG. 4A. In state 210, the destination user device (such as mobile telephone 18) receives the message from the originating user device 12 using the telephone number embedded in the preferences of the browser. In state 215, the destination user device identifies the message as a telephone number record message. The message may be identified as being from the originating user device if so marked by the originating user device before it was sent. In state 220, the destination user device informs the user that a telephone directory message has been received.

If, in state 225, the user decides not to accept the record, then in state 230, the message is deleted. If, in state 225, the user decides to accept the message, then in state 240, the destination user device searches its electronic telephone directory (such as directory 31) to determine whether the telephone number record is already recorded in the electronic telephone directory. If, in state 245, the telephone number has previously been recorded, then in state 250, the destination device notifies the user that the telephone number has previously been recorded so that appropriate action can be taken, such as instructing the electronic telephone directory to only update the fields that have changed. If, in state 245, the telephone number has not been previously recorded, then in state 255, the captured telephone number is recorded in the electronic telephone directory of the destination device. If, in state 260, the message did not contain more than one telephone number record, then in state 265, the method ends. If, in state 260, there was more than one telephone number record entered, then the method continues to record the telephone number records from state 240 through state 265 as discussed above. Optionally, if the electronic telephone directory is formatted into directories or folders or other format for organizing electronic data, a separate folder may be created for downloading telephone number records sent by the originating user device or the server.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

We claim:

1. A method comprising:
entering at least one destination address into a web browser, wherein each destination address is associated with a remote user device having an electronic telephone directory;
entering at least one telephone number record into the web browser; and
sending the at least one telephone number record from the web browser through a network to each remote user device at the at least one destination address.

2. The method of claim 1, further comprising:
recording the at least one telephone number record into the electronic telephone directory of each remote user device.

3. The method of claim 1, further comprising:
d. determining if each telephone number record already exists in the electronic telephone directory, wherein each telephone number record includes a telephone number and an alphanumeric reference;
e. recording each telephone number record into the electronic telephone directory if the telephone number and alphanumeric reference do not already exist in the electronic telephone directory; and
f. providing notification to a user device if the at least one telephone record contains any telephone number or alphanumeric reference that already exists in the electronic telephone directory.

4. The method of claim 3, wherein the step of providing notification further comprises:
g. prompting the user device for an instruction selected from the group consisting of instructions to delete the telephone number record from the message and instructions to update the electronic telephone directory with the telephone number record from the message; and
h. executing the instruction.

5. The method of claim 1, wherein each user device is selected from a mobile telephone, a personal computer, a voice mail messaging service, a FAX machine, a handheld computer, and a personal digital assistant.

6. The method of claim 1, wherein each user device is selected from the group consisting of a device that can store and retrieve information and is connectable to a telephone network, and a device that can store and retrieve information and is connectable to a computer network.

7. The method of claim 1, wherein each destination address is selected from the group consisting of a computer network address, Internet address, and telephone number.

8. The method of claim 1, wherein the at least one telephone number record comprises a telephone number and an alphanumeric identifier for the telephone number.

9. The method of claim 1, wherein the at least one telephone number record comprises parameters selected from the group consisting of a telephone number, contact name, address, FAX number, e-mail address, hyperlink to a web site, business name, business specialty, business hours, and combinations thereof.

10. The method of claim 1, wherein the step of entering the at least one destination address further comprises:
d. selecting a menu function in the web browser for recording the at least one destination address;
e. specifying the at least one destination address on an interactive display provided by the browser; and
f. storing the at least one destination address within the browser program.

11. The method of claim 1, wherein the step of entering the at least one telephone number record further comprises:
d. viewing a web page displaying the at least one telephone number record; and
e. copying the at least one telephone number record from the web page to the browser.

12. The method of claim 11, further comprising:
repeating steps (d) and (e) to enter additional telephone number records.

13. The method of claim 11, wherein each telephone number record comprises a telephone number and an alphanumeric identifier for the telephone number, the method further comprising:
modifying the format of the at least one telephone number record entered to be compatible with the electronic telephone directory at each destination address.

14. The method of claim 1, wherein the step of sending the at least one telephone number record further comprises:
detecting the at least one destination address on the browser;
determining from the at least one destination address the means for sending the message, wherein the means is selected from the group consisting of a computer network and a telephone network; and
composing a message containing the at least one telephone number record.

15. The method of claim 14, further comprising:
marking the message to indicate that the message contains a telephone number record.

16. The method of claim 1, further comprising:
entering a password for the user device on the web browser; and
marking the message with the password.

17. The method of claim 16, wherein the password is recorded into the web browser.

18. A computer program product including instructions embodied on a computer readable medium, the instructions comprising:
entering instructions for entering at least one destination address into a web browser, wherein each destination address is associated with a remote user device having an electronic telephone directory;
entering instructions for entering at least one telephone number record into the web browser; and
sending instructions for sending the at least one telephone number record from the web browser through a network to each remote user device at the at least one destination address.

19. The computer program product of claim 18, further comprising:
recording instructions for recording the at least one telephone number record into the electronic telephone directory of each remote user device.

20. The computer program product of claim 18, further comprising:
determining instructions for determining if each telephone number record already exists in the electronic telephone directory, wherein each telephone number record includes a telephone number and an alphanumeric reference;
recording instructions for recording each telephone number record into the electronic telephone directory if the telephone number and alphanumeric reference do not already exist in the electronic telephone directory; and
notifying instructions for notifying a user device if the at least one telephone record contains any telephone number or alphanumeric reference that already exists in the electronic telephone directory.

21. The computer program product of claim 20, wherein the notifying instructions further comprise:
prompting instructions for prompting the user device for a command selected from the group consisting of instructions to delete the telephone number record from the message and instructions to update the electronic telephone directory with the telephone number record from the message; and
executing instructions for executing the command.

22. The computer program product of claim 18, wherein each user device is selected from a mobile telephone, a personal computer, a voice mail messaging service, a FAX machine, a handheld computer, and a personal digital assistant.

23. The computer program product of claim 18, wherein each user device is selected from the group consisting of a device that can store and retrieve information and is connectable to a telephone network, and a device that can store and retrieve information and is connectable to a computer network.

24. The computer program product of claim 18, wherein each destination address is selected from the group consisting of a computer network address, Internet address, and telephone number.

25. The computer program product of claim 18, wherein the at least one telephone number record comprises a telephone number and an alphanumeric identifier for the telephone number.

26. The computer program product of claim 18, wherein the at least one telephone number record comprises parameters selected from the group consisting of a telephone number, contact name, address, FAX number, e-mail address, hyperlink to a web site, business name, business specialty, business hours, and combinations thereof.

27. The computer program product of claim 18, wherein the entering instructions for entering the at least one destination address further comprise:
providing instructions for providing a menu function in the web browser for recording the at least one destination address;
identifying instructions for identifying the at least one destination address on an interactive display provided by the browser; and
storing instructions for storing the at least one destination address within the browser program.

28. The computer program product of claim 18, wherein each telephone number record comprises a telephone number and an alphanumeric identifier for the telephone number, the computer program product further comprising:
formatting instructions for formatting the at least one telephone number record entered to be compatible with the electronic telephone directory at each destination address.

29. The computer program product of claim 18, wherein the sending instructions further comprise:
identifying instructions for identifying the at least one destination address on the browser;
determining instructions for determining the means for sending the message based upon the at least one destination address, wherein the means is selected from the group consisting of a computer network and a telephone network; and
composing instructions for composing a message containing the at least one telephone number record.

30. The computer program product of claim 29, further comprising:
marking instructions for marking the message to indicate that the message contains a telephone number record.

31. The computer program product of claim 18, further comprising:
entering instructions for entering a password for the user device on the web browser; and
including instructions for including the password along with the telephone number record.

32. The computer program product of claim 31, further comprising:
storing instructions for storing the password into the web browser.

33. The method of claim 1, further comprising:
selecting a telephone number from a web page displayed by the browser;
capturing the selected telephone number into a telephone number record; and
allowing for entry of additional information into the telephone number record.
